(19) United States
(12) Patent Application Publication
(10) Pub. No.: US 2022/0040949 A1
(43) Pub. Date: Feb. 10, 2022

(54) EDGE-CUTTING DEVICE

(71) Applicant: MITSUBISHI HEAVY INDUSTRIES MACHINERY SYSTEMS, LTD., Kobe-shi, Hyogo (JP)

(72) Inventors: Hideki MIZUTANI, Kobe-shi, Hyogo (JP); Kazumi IWASAWA, Kobe-shi, Hyogo (JP)

(21) Appl. No.: 17/433,093

(22) PCT Filed: Feb. 17, 2020
(86) PCT No.: PCT/JP2020/006055

§ 371 Date: Aug. 23, 2021

(30) Foreign Application Priority Data
Feb. 27, 2019 (JP) 2019-033981

(51) Int. Cl. B31B 50/22

(52) U.S. Cl. CPC B31B 50/22

(57) ABSTRACT

An edge-cutting device performs edge-cutting for cutting away trimmings of a corrugated cardboard sheet toward the front and back when switching between orders is to be performed in a corrugating machine. This edge-cutting device has an edge-cutting knife provided to project from the outer circumference of a cylinder having an axis disposed in the width direction of the corrugating machine; and a control device that, when switching between orders is to be performed, controls the edge-cutting device to perform a first edge-cutting process for edge-cutting trimming of an old order at the first rotation of the edge-cutting knife and a second edge-cutting process for edge-cutting trimming of a new order at the second rotation. The control device includes a calculation device for calculating the order switching time, and a variable control device for variably controlling the time interval between the first edge-cutting process and the second edge-cutting process.

### TECHNICAL FIELD

The present invention relates to an edge-cutting device that processes trims in a case where an order is changed in a corrugating machine.

### BACKGROUND ART

As described in, for example, PTL 1, a corrugating machine manufacturing a cardboard sheet is provided with slitter scorers and a cut-off device that are arranged in this order downstream of a double facer. The corrugating machine performs predetermined creasing line forming and slitting, which correspond to an order, on a belt-like double-faced cardboard sheet, which is manufactured by the double facer, by the slitter scorers and then cuts the double-faced cardboard sheet to a predetermined length, which corresponds to the order, by the cut-off device to obtain product sheets.

In a case where machining is performed by the slitter scorers, unnecessary portions called trims are generated on both sides of the belt-like double-faced cardboard sheet due to a difference between the width of a base sheet and the width of the product sheet. The trims are cut by slitter knives of which the positions have been adjusted to positions corresponding to the slitter scorers, and are sent to a trim chute.

Further, the corrugating machine disclosed in PTL 1 has a structure where two slitter scorers, that is, a first slitter scorer and a second slitter scorer are disposed in series as the slitter scorers so as to be capable of coping with the changing of an order without the stop of the corrugating machine. The first slitter scorer and the second slitter scorer can be alternately used in this structure. Accordingly, while the corrugating machine is operated using one slitter scorer, setting corresponding to the next order (new order), such as the movement of slitter knives, can be performed by the other slitter scorer. “The changing of an order” means that an old order ends and a new order starts (that is, an order is shifted to a new order).

An edge-cutting device, which cuts the trims (referred to as edge cutting) of the belt-like double-faced cardboard sheet, is provided immediately upstream of both the slitter scorers. In a case where an order is changed, the trims are separated into trims of the old order and trims of the new order by the edge-cutting device and are discharged to a predetermined trim chute.

FIGS. 7A and 7B are plan views of a cardboard sheet having been subjected to edge cutting. As shown in FIGS. 7A and 7B, a cardboard sheet 110A of an old order is positioned on the downstream side in a transfer direction and a cardboard sheet 110B of a new order is positioned on the upstream side in the transfer direction. Slits 120a and 120b are formed in the respective cardboard sheets 110A and 110B as shown by a two-dot chain line. In FIGS. 7A and 7B, a direction orthogonal to the transfer direction is a machine width direction. Portions positioned outside the slits 120a and 120b in the machine width direction are trims.

FIG. 7A shows an example of a cardboard sheet having been subjected to “single-cut” type edge cutting. The single-cut type edge cutting is machining that makes the slits 120a of the trims of the cardboard sheet 110A of the old order and the slits 120b of the trims of the cardboard sheet 110B of the new order overlap with each other and forms an edge cut 150a at only one position in each overlapping portion.

FIG. 7B shows an example of a cardboard sheet having been subjected to “multi-cut” type edge cutting. The multi-cut type edge cutting is machining that provides a blank portion 130 between the cardboard sheet 110A of the old order and the cardboard sheet 110B of the new order and forms edge cuts 150b and 150c at two positions in each of a start portion and an end portion of the blank portion 130.

In the single-cut type edge cutting, portions where the lengths of scratches caused on the front and rear sides of the slits 120a and 120b by the slitter knives and margins are added to the overlapping portions are defective sheets.

On the other hand, since scratches caused on the front and rear sides of the slits 120a and 120b are formed in the blank portion 130 in the multi-cut type edge cutting, only the blank portion 130 between the edge cuts 150b, which are end portions of the old order, and the edge cuts 150c, which are start portions of the new order, is a defective sheet. As a result, an increase in the length of the defective sheet can be suppressed.

Further, the structure of a corrugating machine in the related art that includes a plurality of (for example, two) cut-off devices and a director device disposed between a slitter scorer and the plurality of cut-off devices as described in, for example, PTL 2 is known. In the corrugating machine having this structure, a plurality of cardboard sheets formed by the slitter scorer can be separated from each other in a machine width direction and distributed to the plurality of cut-off devices by the director device. In this case, a center-cutting device is provided upstream of the slitter scorer in order to make the cardboard sheets of the new and old orders, which are distributed to the respective cut-off devices, continuous in a case where an order is changed. This center-cutting device performs center cutting for forming a center cut connecting the positions of slits that are distributed portions of the new and old orders (see, for example, PTL 2).

It is assumed in, for example, FIG. 7C that the first cardboard sheets 110A and 110B and the second and third cardboard sheets 110A′ and 110B′ are distributed to different cut-off devices, respectively. In this case, the center-cutting device forms a center cut 160 connecting a slit 120c between the cardboard sheets 110A and 110A′, which are distributed portions of the old order, to a slit 120d between the cardboard sheets 110B and 110B′, which are distributed portions of the new order, in a case where an order is changed. A blank portion 130 and a blank portion 130′ are separated from each other by the center cut 160.

As described above, various kinds of machining and setting, such as edge cutting performed by the edge-cutting device, center cutting performed by the center-cutting device, and the setting of the slitter scorers corresponding to the new order, are performed in the corrugating machine as preparatory work in a case where an order is changed.

### CITATION LIST

### Patent Literature

[PTL 1] Japanese Unexamined Patent Application Publication No. 2012-152847

[PTL 2] International Publication No. WO 2018-155507

### SUMMARY OF INVENTION

### Technical Problem

Incidentally, the edge-cutting device in the related art disclosed in PTL 1 includes edge-cutting knives that protrude from the outer peripheries of cylinders and anvil cylinders that are disposed on one side of a transfer line for a cardboard sheet so as to face the edge-cutting knives, and is adapted to perform edge cutting on the trims of a belt-like cardboard sheet between the rotationally driven edge-cutting knives and the anvil cylinders.

In a case where the edge-cutting device in the related art is to perform multi-cut type edge cutting, the edge-cutting device accelerates the edge-cutting knives to the same speed as the transfer speed of the cardboard sheet from predetermined standby positions and then forms the first edge cuts 150b by the first edge cutting as shown in FIG. 7B. After that, in a case where the edge-cutting knives are rotated once in a state where the same speed is maintained, the second edge cuts 150c are formed by second edge cutting.

While the first edge cutting and the second edge cutting are performed, the rotation of the edge-cutting knives is normally controlled at a constant speed that is the same speed as the transfer speed of a cardboard sheet. Accordingly, the length of the blank portion 130 is defined by the peripheral distance of the edge-cutting knife (hereinafter referred to as “a knife peripheral length”).

However, since various kinds of machining and setting, such as center cutting and the setting of the slitter scorers corresponding to the new order in addition to the edge cutting, are performed as described above in the corrugating machine as preparatory work in a case where an order is changed, a length required for the blank portion 130 is based on a time required for the preparatory work in a case where an order is changed (order changing time).

For example, in a case where the center cutting is performed, an order cannot be shifted to a new order until the formation of the center cut 160 connecting the slit 120c between the cardboard sheets 110A and 110A′ of the old order to the slit 120d between the cardboard sheets 110B and 110B′ of the new order as shown in FIG. 7C is completed. Accordingly, a time equal to or longer than a time required to form the center cut 160 by the center-cutting device needs to be secured as a time interval between the first edge cutting and the second edge cutting that are performed by the edge-cutting device. In other words, a length required for the blank portion 130 is changed depending on the length L1 of the center cut, and a length longer than at least the length L1 of the center cut needs to be ensured as the length required for the blank portion 130.

The length required for the blank portion 130 is determined from the knife peripheral length and the length L1 of the center cut, and is represented by the following expression. a in the following expression is an arbitrary natural number.

Length of blank portion=knife peripheral length×a>length of center cut

That is, in a case where the edge-cutting knives are rotated once to perform the multi-cut type edge cutting, the first edge cuts 150b and the second edge cuts 150c are obtained. However, in a case where the length L1 of the center cut is longer than the knife peripheral length, the edge-cutting knives need to be rotated once more. This increases the length of a defective sheet that is generated in a case where an order is changed.

Further, the structure (single slitter) of a corrugating machine in the related art including only one slitter scorer is also known. In the structure including the single slitter, in order to change an order without stopping the corrugating machine, a slitter knife of the slitter scorer is moved to a retreat position from an operating position at the end timing of an old order first, is moved in the machine width direction to a slitting position corresponding to a new order in this state, and then returns to the operating position from the retreat position. Accordingly, since the setting of the slitter scorer is not completed in the structure including the single slitter until the slitter knife returns to the operating position again, an order cannot be shifted to a new order.

In this case, a time equal to or longer than a time required for the setting of the slitter scorer needs to be secured as a time interval between the first edge cutting and the second edge cutting that are performed by the edge-cutting device. In other words, a length required for the blank portion 130 is changed depending on a time required for the setting of the slitter scorer, and the edge-cutting knives need to be rotated once more in a case where the time required for the setting is longer than the time interval between the first edge cutting and the second edge cutting. This increases the length of a defective sheet that is generated in a case where an order is changed.

In a case where the edge-cutting device is to perform the multi-cut type edge cutting in this way, a time equal to or longer than a time (order changing time) required for the preparatory work in a case where an order is changed needs to be secured as a time interval between the first edge cutting and the second edge cutting.

However, the length of the blank portion 130 is defined by the knife peripheral length in the edge-cutting device in the related art, which increases the length of a defective sheet that is generated in a case where an order is changed. For this reason, there is room for improvement in the suppression of an increase in the length of the defective sheet.

Since corrugating machines have tended to produce product sheets in small lots in recent years, the frequency of the changing of an order has been increasing. For this reason, there is an increasing demand for the suppression of an increase in the length of the defective sheet caused by the changing of an order.

An edge-cutting device of the invention has been devised in consideration of such a problem, and an object of the invention is to suppress an increase in the length of a defective sheet caused by the changing of an order in the edge-cutting device. The object of the invention is not limited to this object, and obtaining operational effects, which are derived from the respective configurations described in Description of Embodiments to be described later and are not obtained in the related art, is also be another object of the invention.

### Solution to Problem

(1) An edge-cutting device of the invention performs edge cutting for cutting away a trim of a cardboard sheet forward and backward in a case where an order is changed in a corrugating machine. The edge-cutting device includes an edge-cutting knife that protrudes from an outer periphery of a cylinder of which an axis is disposed in a width direction of the corrugating machine and is rotated integrally with the cylinder, and a control device that controls the edge-cutting device to cause the edge-cutting device to perform first edge cutting for edge-cutting a trim of an old order at a first rotation of the edge-cutting knife and to perform second edge cutting for edge-cutting a trim of a new order at a second rotation of the edge-cutting knife in a case where the order is changed. The control device includes calculation means for calculating an order changing time, and variable control means for variably controlling a time interval between the first edge cutting and the second edge cutting in the order changing time.

(2) It is preferable that the variable control means controls a rotation speed of the edge-cutting knife between an end point in time of the first edge cutting and a start point in time of the second edge cutting.

(3) It is preferable that the corrugating machine includes a center-cutting device forming a center cut connecting a position of a slit of the cardboard sheet of the old order to a position of a slit of the cardboard sheet of the new order in a case where the order is changed, and the calculation means calculates a center-cutting time, which is required to form the center cut by the center-cutting device, as the order changing time.

(4) It is preferable that the corrugating machine includes a slitter scorer that forms a slit in a transfer direction in the cardboard sheet and the calculation means calculates a slitter scorer-setting time, which is required to switch the slitter scorer to setting for the new order from setting for the old order, as the order changing time in a case where the order is changed.

(5) It is preferable that the corrugating machine includes the center-cutting device and the slitter scorer, and the calculation means calculates the center-cutting time and the slitter scorer-setting time and employs a longer time of the center-cutting time and the slitter scorer-setting time as the order changing time.

### Advantageous Effects of Invention

According to the edge-cutting device of the invention, since the time interval between the first edge cutting and the second edge cutting is variably controlled at the order changing time, a distance between the position of the edge cut formed by the first edge cutting and the position of the edge cut formed by the second edge cutting can be minimized with respect to the length of a blank portion required for the changing of an order. Accordingly, since an increase in the length of a defective sheet caused by the changing of an order can be suppressed, productivity can be improved.

### BRIEF DESCRIPTION OF DRAWINGS

FIG. 1 is a schematic side view illustrating the configuration of a corrugating machine including an edge-cutting device according to an embodiment.

FIG. 2 is a perspective view illustrating a more specific configuration example of the edge-cutting device according to the embodiment.

FIG. 3 is a flowchart illustrating a procedure of edge-cutting control according to the embodiment.

FIG. 4 is a timing chart illustrating an example of control of the rotation speed of an edge-cutting knife according to the embodiment.

FIG. 5 is a diagram illustrating the action of the edge-cutting device according to the embodiment and is a plan view of a cardboard sheet.

FIG. 6 is a schematic side view illustrating the corrugating machine that includes the edge-cutting device according to the embodiment and has the structure of a single slitter.

FIG. 7A is a diagram illustrating a related art and is a diagram illustrating single-cut type edge cutting.

FIG. 7B is a diagram illustrating a related art and is a diagram illustrating multi-cut type edge cutting.

FIG. 7C is a diagram illustrating a related art and is a diagram illustrating center cutting.

### DESCRIPTION OF EMBODIMENTS

An edge-cutting device as an embodiment will be described with reference to the drawings. The embodiment described below is merely an example and there is no intention to exclude the application of various modifications and techniques that are not specified in the following embodiment. The respective configurations of this embodiment can have various modifications without departing from the scopes thereof. Further, the respective configurations can be selected as necessary, or can be appropriately combined.

[1. Configuration of Corrugating Machine]

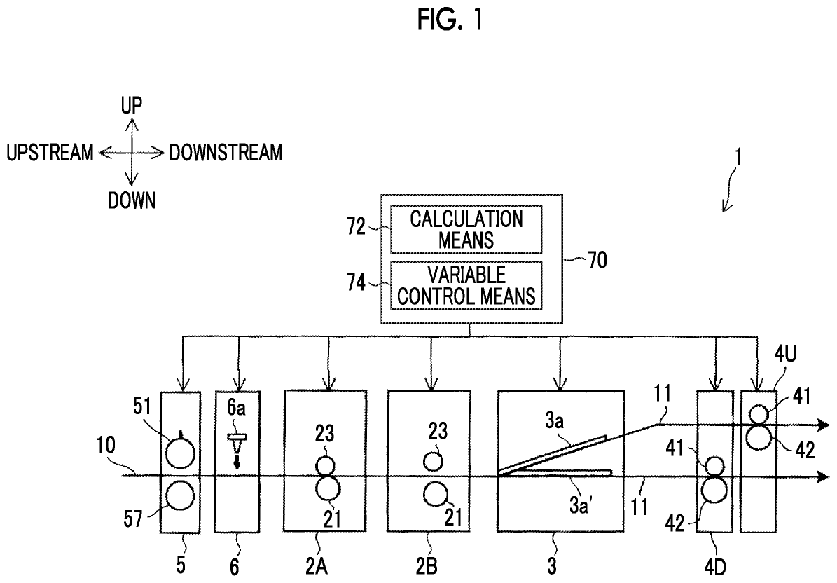

FIG. 1 is a schematic side view illustrating the configuration of a main portion of a downstream portion (dry end) of a corrugating machine including an edge-cutting device according to an embodiment.

Directions (up, down, upstream, and downstream) in the drawings indicate directions based on the transfer direction of the corrugating machine. Since the corrugating machine is usually installed on a horizontal surface, the up-down direction of the corrugating machine coincides with a vertical direction. Further, a direction orthogonal to the transfer direction is defined as the width direction of the corrugating machine (referred to as a machine width direction). Furthermore, a downstream side in the transfer direction is defined as a front side, and an upstream side in the transfer direction is defined as a rear side.

As shown in FIG. 1, the corrugating machine 1 includes a first slitter scorer 2A, a second slitter scorer 2B, a director device 3, an upper cut-off device 4U, and a lower cut-off device 4D. An edge-cutting device 5 is further provided upstream of the first slitter scorer 2A and a center-cutting device 6 is further provided between the edge-cutting device 5 and the first slitter scorer 2A. For convenience of illustration, the upper cut-off device 4U and the lower cut-off device 4D are shown so that the positions of the upper cut-off device 4U and the lower cut-off device 4D are shifted from each other in the transfer direction. However, the upper cut-off device 4U and the lower cut-off device 4D may be disposed on two stages, that is, the upper and lower stages at the same position in the transfer direction.

The first slitter scorer 2A and the second slitter scorer 2B, that is, two slitter scorers 2 (denoted by reference numeral 2 in a case where the first and second slitter scorers are not distinguished from each other) are disposed in series and are adapted to cope with the changing of an order without stopping the corrugating machine 1. That is, while one slitter scorer 2 is operated, a preparation corresponding to the next order is made in the other slitter scorer 2.

Each slitter scorer 2 includes a disc-like slitter knife 21 that is provided on one side (here, the lower side) of a transfer line 10 along which a belt-like double-faced cardboard sheet 11 is to be transferred, and an opposite roll 23 that faces the slitter knife 21 and is provided on the other side (here, the upper side) of the transfer line 10. A plurality of sets of the slitter knife 21 and the opposite roll 23 are arranged side by side in the machine width direction. Each slitter scorer 2 includes other components, such as a creasing roll for performing creasing and a trim chute for processing trims, but these components are not shown and described.

In a case where the slitter knife 21 is raised so as to reach a position where the outer periphery of the slitter knife 21 penetrates the double-faced cardboard sheet 11 traveling along the transfer line 10 and the opposite roll 23 is set to an operating position where the opposite roll 23 is lowered to the transfer line 10, slitting using the slitter knife 21 is performed. The slitter knife 21 of the first slitter scorer 2A shown in FIG. 1 is set to the operating position.

On the other hand, in a case where the slitter knife 21 is lowered to a position where the slitter knife 21 does not interfere with the transfer line 10 and the opposite roll 23 is set to a retreat position where the opposite roll 23 is raised to a position where the opposite roll 23 does not interfere with the transfer line 10, the slitter knife 21 can be moved in the machine width direction to a slitting position corresponding to the next order. The slitter knife 21 of the second slitter scorer 2B shown in FIG. 1 is set to a retreat position.

The director device 3 includes a plurality of (for example, six) strip-like plates 3a and 3a′ disposed under the cardboard sheet 11 traveling along the transfer line 10, and functions to distribute the cardboard sheet 11 to the cut-off devices 4U and 4D provided downstream. Each of the plates 3a and 3a′ is adapted to be capable of individually oscillating about an upstream end thereof by a drive mechanism (not shown) so that the longitudinal direction of each plate is directed in the transfer direction, and is set to any one attitude of a horizontal attitude (reference numeral 3a′) or an inclined attitude (reference numeral 3a) where the plate is upward inclined toward the downstream from the upstream. The plates 3a set to the inclined attitude distribute some of a plurality of cardboard sheets 11, which are formed by the slitter scorers 2, to the upper cut-off device 4U, and the plates 3a′ set to the horizontal attitude distribute some of the rest of the plurality of cardboard sheets 11 to the lower cut-off device 4D.

The upper cut-off device 4U and the lower cut-off device 4D (denoted by reference numeral 4 in a case where the upper cut-off device 4U and the lower cut-off device 4D are not distinguished from each other) are adapted to have the same structure.

As shown in FIG. 1, a double-blade cut-off device, which includes knife cylinders 41 and 42 on both upper and lower sides, is provided as the cut-off device 4 in this embodiment. The respective knife cylinders 41 and 42 are rotated at a timing corresponding to an order, cut the belt-like double-faced cardboard sheet 11 to a predetermined length, and obtain product sheets.

A defective sheet-removing device and a stacker (not shown) are provided in this order downstream of the cut-off devices 4, specify a defective sheet among the product sheets on the basis of machining information or product inspection information checked on the upstream side, and separates the defective sheet from the transfer line 10 for a proper product sheet. Accordingly, only proper product sheets are stacked on the stacker provided downstream of the defective sheet-removing device.

In a case where machining is performed by the slitter scorers 2, unnecessary portions called trims are generated on both sides of the belt-like double-faced cardboard sheet 11 due to a difference between the width of a base sheet and the width of the product sheet. The trims are cut by the slitter knives 21 of which the positions have been adjusted to corresponding positions, are sent to the trim chute (not shown), and are removed from the transfer line 10 downstream of the slitter scorers 2.

Further, the edge-cutting device 5, which cuts trims (referred to as edge cutting) in the width direction in a case where an order is changed, is provided immediately upstream of both the slitter scorers 2A and 2B. In a case where an order is changed, the trims are separated into trims of an old order and trims of a new order by the edge-cutting device 5 and are discharged to a predetermined trim chute (not shown). “Changing of an order” in this embodiment is to end an old order and to start a new order.

The edge-cutting device 5 is provided with edge-cutting knives 51 that protrude from the outer peripheries of cylinders which are disposed on one side (here, the upper side) of the transfer line 10 and of which the axes are disposed in the machine width direction and anvil cylinders 57 that are provided on the other side (here, the lower side) of the transfer line 10 and faces the edge-cutting knives 51. The edge-cutting device 5 rotationally drives the edge-cutting knives 51 to perform edge cutting on the trims of a belt-like cardboard sheet between the edge-cutting knives 51 and the anvil cylinders 57.

The edge-cutting device 5 according to this embodiment is formed as the edge-cutting device 5 that performs multi-cut type edge cutting. That is, in a case where an order is changed, the edge-cutting device 5 is provided with a blank portion 13 (see FIG. 5 to be described later) between a cardboard sheet 11A of an old order and a cardboard sheet 11B of a new order and forms edge cuts at two positions, that is, a start portion and an end portion of the blank portion.

In a case where an order is changed, a slit is not formed at the blank portion and slits of a new order and an old order are discontinuous. For this reason, the center-cutting device 6 performs center cutting for forming a center cut 16 (see FIG. 5 to be described later) connecting a slit 12c between cardboard sheets 11A and 11A′, which are distributed portions of the old order, to a slit 12d between cardboard sheets 11B and 11B′, which are distributed portions of the new order, in a case where an order is changed.

The center-cutting device 6 includes a jet nozzle 6a (see FIG. 1) that is provided above the transfer line 10 and a moving mechanism (not shown). The jet nozzle 6a jets liquid to the cardboard sheet 11 as shown in FIG. 1 by a black arrow. The moving mechanism (not shown) moves the jet nozzle 6a in the machine width direction. The jet nozzle 6a is moved in the machine width direction to the position of the slit of the new order from the position of the slit of the old order by the moving mechanism (not shown) while jetting liquid. Accordingly, the cardboard sheet 11 is cut by the jetted liquid, so that the center cut 16 (see FIG. 5 to be described later) is formed.

[2. Configuration Example of Edge-Cutting Device]

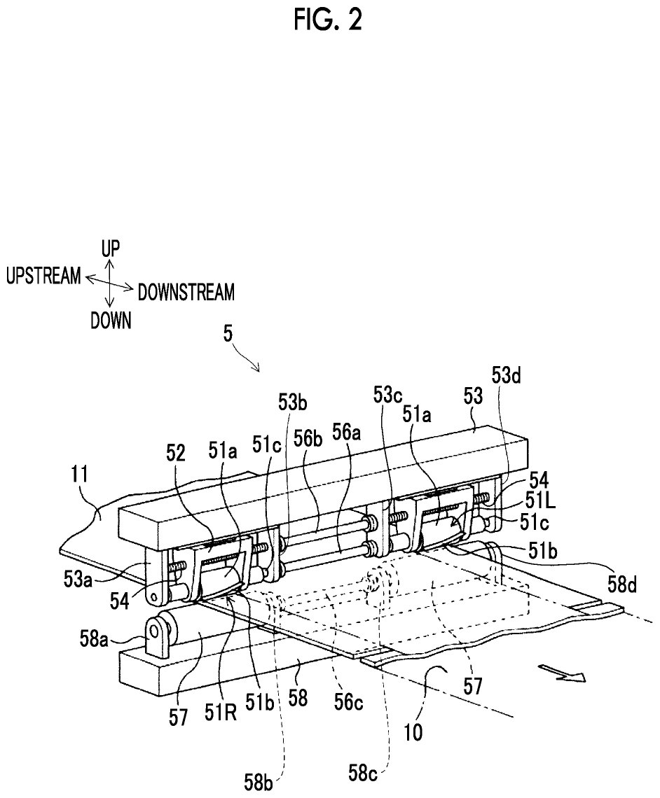

Next, an example of the more specific configuration of the edge-cutting device 5 according to this embodiment is shown in FIG. 2. The edge-cutting device 5 shown in FIG. 2 is provided with the edge-cutting knives divided into two edge-cutting knives, that is, a first edge-cutting knife 51R and a second edge-cutting knife 51L. The first edge-cutting knife 51R is disposed so as to correspond to one of end portions of the belt-like double-faced cardboard sheet 11 in the width direction, and the second edge-cutting knife 51L is disposed so as to correspond to the other of the end portions of the double-faced cardboard sheet 11 in the width direction. The respective edge-cutting knives 51 (denoted by reference numeral 51 in a case where the first and second edge-cutting knives 51R and 51L are not distinguished from each other) include helical knives 51b that protrude from the outer peripheries of cylinders 51a so as to have different phases in an axial direction.

Rotating shafts 51c of these edge-cutting knives 51 are joined to the cylinders 51a by serration so as to be rotated integrally with the cylinders 51a and movable relative to the cylinders 51a in the axial direction. Both ends of the respective rotating shafts 51c are rotatably supported by brackets 53a to 53d fixed to a first beam 53 that is provided above the edge-cutting knives 51 and extends in the machine width direction.

A moving head 52, which is joined to the edge-cutting knife 51 and supports the edge-cutting knife 51, is interposed between each edge-cutting knife 51 and the first beam 53. A ball screw 54 penetrates each moving head 52. The ball screws 54 are rotatably supported by the brackets 53a to 53d. Accordingly, in a case where the ball screw 54 is rotated, each moving head 52 is moved in the machine width direction together with each edge-cutting knife 51.

The anvil cylinders 57 are provided on the other side of the transfer line 10 for the double-faced cardboard sheet 11 so as to face the edge-cutting knives 51. Each of the anvil cylinders 57 includes an elastic body that is mounted on the outer peripheral surface of a cylinder. In a case where the edge-cutting knives 51 cut trims from above, the anvil cylinders 57 support the double-faced cardboard sheet 11 from below. Accordingly, the double-faced cardboard sheet 11 does not escape downward.

In this embodiment, the anvil cylinders 57 are divided and coaxially disposed so as to correspond to both end portions of the cardboard sheet 11, and shaft portions provided at both ends of all of these anvil cylinders 57 are rotatably supported by brackets 58a to 58d fixed to a second beam 58 that is provided below the anvil cylinders 57 and extends in the machine width direction. Each anvil cylinder 57 is merely rotated by the movement of the cardboard sheet 11 without being moved in the axial direction. Accordingly, the length of the outer peripheral surface of each anvil cylinder 57 in the axial direction is set to a length that can cover the moving range of the edge-cutting knife 51 in the axial direction.

Further, the rotating shafts 51c of the respective edge-cutting knives 51 are coaxially connected to each other by a connection shaft 56a, the ball screws 54 threadedly engaged with the respective moving heads 52 are coaxially connected to each other by a connection shaft 56b, rotating shafts of the respective anvil cylinders 57 are coaxially connected to each other by a connection shaft 56c, and the rotating shafts 51c and the ball screws 54 are rotationally driven by driving sources (not shown) connected to drive-side end portions thereof, respectively.

The edge-cutting device 5 normally causes the edge-cutting knives 51 to stop and stand by at rotation phases (standby positions) where the knives 51b do not interfere with the double-faced cardboard sheet 11 above the transfer line 10, is started in a case where an order is changed, and performs edge cutting by edge-cutting control to be described later.

[3. Control Configuration]

The corrugating machine 1 includes a control device 70 to control the operations of the respective parts.

As preparatory work in a case where an order is changed, the control device 70 performs the setting of each slitter scorer 2, the setting of the cut-off device 4, edge-cutting control for controlling the operation of the edge-cutting device 5, or center-cutting control for controlling the operation of the center-cutting device 6.

Here, description will be made while focusing on the edge-cutting control for controlling the operation of the edge-cutting device 5.

The outline of the edge-cutting control is as follows. First, in a case where it is determined that an order starts to be changed, the edge-cutting device 5 starts the edge-cutting knives 51 from the standby positions and accelerates the edge-cutting knives 51 in about a half of rotation until the edge-cutting knives 51 reach a peripheral speed (cutting speed) equal to the transfer speed of the double-faced cardboard sheet 11 on the transfer line 10. Then, the edge-cutting device 5 performs first edge cutting while rotating the edge-cutting knives 51 at the cutting speed. After that, the edge-cutting device 5 rotates the edge-cutting knives 51 once to perform second edge cutting. After the second edge cutting is completed, the edge-cutting knives 51 are decelerated from the cutting speed in about a half of rotation and are stopped at the standby positions.

That is, in a case where the edge-cutting device 5 performs multi-cut type edge cutting, the edge-cutting knives 51 are rotated about twice until the edge-cutting device 5 starts the edge-cutting knives 51 from the standby positions, performs the first edge cutting, and the edge-cutting knives 51 are stopped at the standby positions again. The first edge cutting is performed during the first rotation of the edge-cutting knives 51, and the second edge cutting is performed during the second rotation thereof.

As described above, in this embodiment, the setting of each slitter scorer 2, the setting of the cut-off device 4, and center cutting need to be performed in addition to edge cutting as the preparatory work in a case where an order is changed. Further, an order cannot be shifted to a new order until the preparatory work in a case where an order is changed (center cutting in this embodiment) is completed. For this reason, a time equal to or longer than a time (order changing time) required for the preparatory work in a case where an order is changed needs to be secured as a time interval (also referred to as an edge cut interval) between the first edge cutting and the second edge cutting.

In this regard, the edge cut interval is variably controlled in the order changing time in the edge-cutting control of this embodiment, so that the edge cut interval can be made to match the order changing time and the length of a blank portion caused by the changing of an order can be minimized.

As shown in FIG. 1, the control device 70 is provided with calculation means 72 for calculating an order changing time, and variable control means 74 for variably controlling the edge cut interval in the calculated order changing time. The calculation means 72 and the variable control means 74 are provided as functional elements that are used to variably control the edge cut interval between the first edge cutting and the second edge cutting in the order changing time. These elements 72 and 74 are elements that represent the functions of the control device 70 classified for convenience, and are provided as software executed by a hardware resource that is the control device 70.

The calculation means 72 calculates an order changing time on the basis of the specifications of a new order in a case where there is a request for changing an order. The order changing time is a time required for the preparatory work in a case where an order is changed (center cutting in the case of this embodiment).

Specifically, examples of the order changing time include a time (referred to as a center-cutting time) required until the above-mentioned center-cutting device 6 ends machining for forming a center cut 16 after starting the machining for forming the center cut 16 and a time (referred to as a slitter scorer-setting time) required to change the slitter scorers 2 to setting for a new order from setting for an old order. The slitter scorer-setting time includes a time required to lower the slitter knife to a position where the slitter knife 21 does not interfere with the transfer line 10 in order to set the slitter knife 21 to the retreat position, a time required to move the slitter knife 21 in the machine width direction to a slitting position corresponding to the next order, and a time required to raise the slitter knife 21 in order to set the slitter knife 21 to the operating position so that the slitter knife 21 reaches a position where the outer periphery of the slitter knife 21 penetrates the double-faced cardboard sheet 11 traveling along the transfer line 10.

The calculation means 72 of this embodiment is adapted to calculate the center-cutting time and the slitter scorer-setting time and to employ a longer time of the calculated center-cutting time and the calculated slitter scorer-setting time as the order changing time. The corrugating machine 1 of this embodiment includes the two slitter scorers 2A and 2B, and is adapted to cope with the changing of an order without being stopped. For example, during the operation of the slitter scorer 2A, the slitter scorer 2B can move the slitter knife 21 in the machine width direction to a slitting position corresponding to the next order. In this case, the slitter scorer-setting time is only a time required to set the slitter knife 21 to the retreat position in the slitter scorer 2A and a time required to set the slitter knife 21 to the operating position in the slitter scorer 2B. Accordingly, since the center-cutting time is longer than the slitter scorer-setting time, the center-cutting time is employed as the order changing time in this embodiment.

The variable control means 74 variably controls the edge cut interval in the calculated order changing time. In detail, the variable control means 74 variably controls the edge cut interval by controlling the rotation speeds of the edge-cutting knives 51 so that the edge-cutting knives 51 are rotated once in the order changing time.

[4. Flowchart]

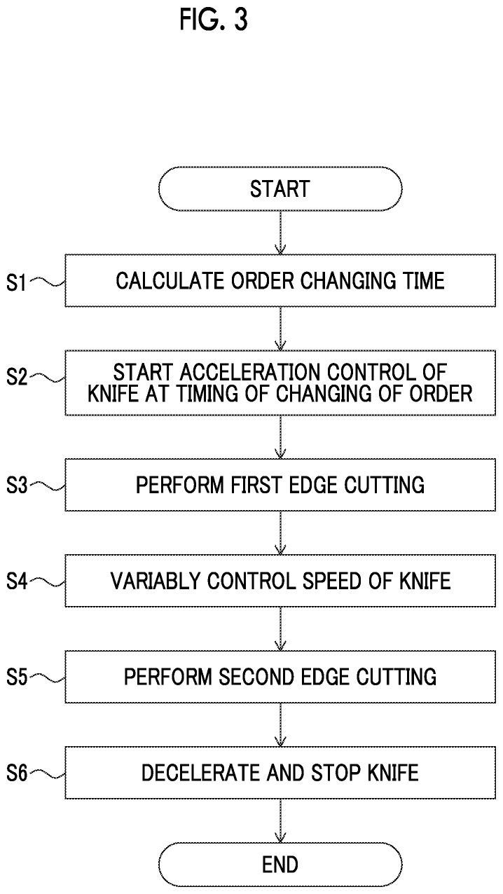

FIG. 3 is a flowchart illustrating a procedure of the edge-cutting control of this embodiment.

The flowchart of FIG. 3 is performed in the control device 70 in a case where there is a request for changing an order.

In Step S1, the calculation means 72 calculates an order changing time.

In Step S2, the edge-cutting knives 51 are started from the standby positions at the timing of changing of an order and the rotation speeds of the edge-cutting knives 51 are increased in about a half of rotation until the edge-cutting knives 51 reach a peripheral speed (cutting speed) V1 equal to the transfer speed of the double-faced cardboard sheet 11 on the transfer line 10.

In Step S3, first edge cutting is performed in a state where the edge-cutting knives 51 are maintained at the peripheral speed (cutting speed) V1 equal to the transfer speed.

In Step S4, after the first edge cutting is performed, the variable control means 74 variably controls the edge cut interval by variably controlling the rotation speeds of the edge-cutting knives 51 so that the edge-cutting knives 51 are rotated once in the order changing time.

In Step S5, second edge cutting is performed in a case where the edge-cutting knives 51 have been rotated once after the first edge cutting.

In Step S6, after the second edge cutting, the edge-cutting knives 51 are decelerated from the cutting speed in about a half of rotation and are stopped at the standby positions.

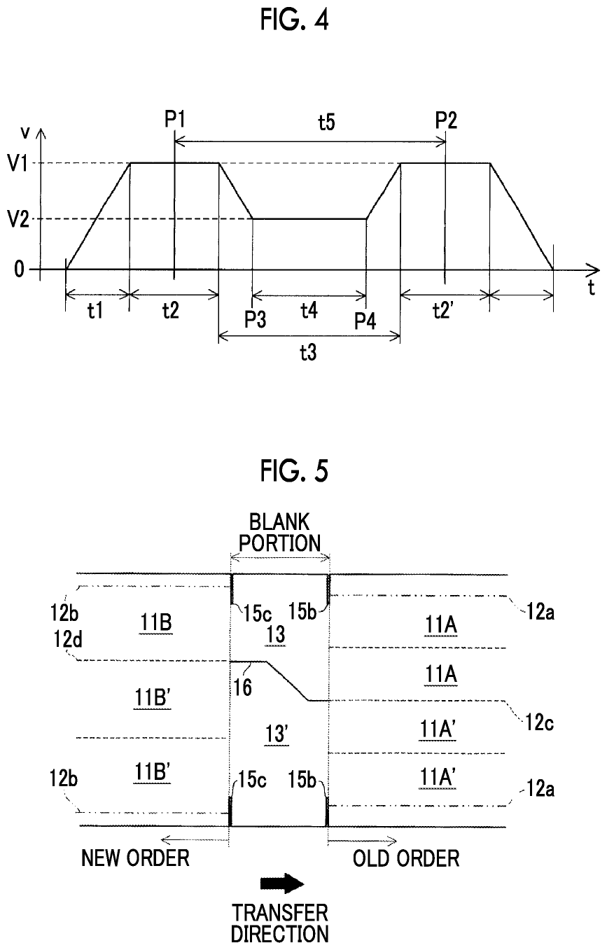

FIG. 4 is a timing chart illustrating an example of the control of the rotation speed of each edge-cutting knife performed in Steps S2 to S6 shown in FIG. 3. In FIG. 4, a horizontal axis represents a time t and a vertical axis represents the rotation speed v of the edge-cutting knife. A case where the variable control means 74 performs control to increase the rotation speed of the edge-cutting knife 51 to the cutting speed V1 after reducing the rotation speed of the edge-cutting knife 51 to a certain low speed (the lowest speed) V2 from the cutting speed V1 is shown in FIG. 4 by way of example.

As shown in FIG. 4, the rotation speed of the edge-cutting knife 51 is increased to the cutting speed V1 from a stopping state in an acceleration time t1 (processing of Step S2). The rotation angle (acceleration angle) of the edge-cutting knife 51 at which acceleration control is performed is set to 150°.

In a subsequent synchronization time t2, the edge-cutting knife 51 performs the first edge cutting while maintaining a rotation speed at the cutting speed V1 (processing of Step S3).

The rotation angle (synchronization angle) 0 of the edge-cutting knife 51 between the start of the first edge cutting and the end thereof is set to 60°. A time required in this case is defined as a synchronization time t2. In a case where the radius of rotation of the edge-cutting knife 51 is denoted by “r”, the synchronization time t2 is represented by the following equation.

Synchronization time t2=r×θ/V1

Further, a synchronization time t2′ is a time required between the start of the second edge cutting and the end thereof, and is represented by the same equation as that of the synchronization time t2.

First edge cuts 15b (see FIG. 5 to be described later) are formed by the first edge cutting at the timing of an intermediate point P1 in time of the synchronization time t2. Further, second edge cuts 15c (see FIG. 5 to be described later) are formed by the second edge cutting at the timing of an intermediate point P2 in time of the synchronization time t2′.

Each edge-cutting knife 51 is rotated once (rotated by an angle of 360°) between the point P1 in time and the point P2 in time. A time required in this case is called an edge-cutting time t5. In this embodiment, this edge-cutting time t5 is given as the order changing time calculated by the calculation means 72 (processing of Step S1). That is, the rotation speed of each edge-cutting knife 51 is variably controlled so that each edge-cutting knife 51 is rotated once (rotated by an angle of 360°) in the edge-cutting time t5 given as the order changing time (processing of Step S4).

The variable control of the rotation speed of each edge-cutting knife 51 (the adjustment of the edge cut interval) is performed in an edge cut interval-adjustment time t3 of the edge-cutting time t5. Since each of the synchronization times t2 and t2′ of the first edge cutting and the second edge cutting needs to be secured by a predetermined time (a synchronization angle θ of 60°), the edge cut interval-adjustment time t3 is a time between an end point in time of the first edge cutting (an end point in time of the synchronization time t2) and a start point in time of the second edge-cutting (a start point in time of the synchronization time t2′). The edge cut interval-adjustment time t3 is represented by the following equation.

Edge cutinterval-adjustment time t3=t5−t2

Further, since the rotation angle (synchronization angles) of each edge-cutting knife 51 in the synchronization time t2 is θ and the rotation angle of the edge-cutting knife 51 in the edge-cutting time t5 is 360°, the rotation angle of each edge-cutting knife 51 in the edge cut interval-adjustment time t3 is expressed by “(2π−θ)” from the equation. In this embodiment, the rotation angle of each edge-cutting knife 51 in the edge cut interval-adjustment time t3 is 300°.

Accordingly, the movement distance (rotating peripheral length) b of each edge-cutting knife 51 in the edge cut interval-adjustment time t3 is represented by the following equation.

Movement distance b=r×(2π−θ)

Here, in a case where acceleration/deceleration at the time of the adjustment of the edge cut interval is set to a constant value α (that is, acceleration α and deceleration −α) and the lowest speed of each edge-cutting knife 51 at the time of the adjustment of the edge cut interval is denoted by V2, α and V2 are obtained from the following equations (1) and (2).

b=(V1+V2)×(V1−V2)/α+V2×t4 (1)

t4=t3−(V1−V2)/α×2 (2)

Here, t4 denotes a time between a point in time that is set as a completion point P3 in time of primary deceleration at the time of the adjustment of the edge cut interval and a point in time that is set as a start point P4 in time of secondary acceleration at the time of the adjustment of the edge cut interval.

Accordingly, in Step S4, the rotation speed of each edge-cutting knife 51 can be variably controlled using the edge cut interval-adjustment time t3, the time t4, acceleration/deceleration a, and the lowest speed V2. That is, the rotation speed of each edge-cutting knife 51 is reduced to the lowest speed V2 from the cutting speed V1 until the completion point P3 in time of primary deceleration after the synchronization time t2, and is maintained at V2 in the time t4. After that, the rotation speed of each edge-cutting knife 51 is increased to the cutting speed V1 from the lowest speed V2 until the end point in time of the edge cut interval-adjustment time t3 after the time t4 passes (from the start point P4 in time of secondary acceleration).

Then, the cutting speed V1 is maintained in the synchronization time t2′ and the second edge cutting is performed (processing of Step S5). After that, after the synchronization time t2′, each edge-cutting knife 51 is decelerated in a rotation angle (deceleration angle) of 150° and is in a stopping state (processing of Step S6). Accordingly, the edge cutting is completed.

[5. Action]

FIG. 5 is a plan view of the cardboard sheet that is subjected to the multi-cut type edge cutting by the edge-cutting device 5 according to this embodiment. A case where four cardboard sheets 11A, 11A, 11A′, and 11A′ are formed in an old order by the slitter scorers 2 and three cardboard sheets 11B, 11B′, and 11B′ are formed in a new order by the slitter scorers 2 is shown in FIG. 5 by way of example. In this embodiment, the cardboard sheets 11A, 11A, and 11B are distributed to the upper cut-off device 4U by the director device 3 and the cardboard sheets 11A′, 11A′, 11B′, and 11B′ are distributed to the lower cut-off device 4D by the director device 3.

As shown in FIG. 5, both sides of the cardboard sheet 11A of the old order are cut at the positions of the slits 12a and first edge cuts 15b formed by the first edge cutting are formed at the rear ends of the slits 12a.

Further, both sides of the cardboard sheet 11B of the new order are cut at the positions of the slits 12b and second edge cuts 15c formed by the second edge cutting are formed at the front ends of the slits 12b.

Blank portions 13 and 13′ are formed between the front end (the positions of the second edge cuts 15c) of the cardboard sheet 11B of the new order and the rear end (the positions of the first edge cuts 15b) of the cardboard sheet 11A of the old order.

Furthermore, the center cut 16 is formed between the slit 12c that is a distributed portion between the cardboard sheets 11A and 11A′ of the old order and the slit 12d that is a distributed portion between the cardboard sheets 11B and 11B′ of the new order.

The blank portions 13 and 13′ are separated from each other by the center cut 16, so that the cardboard sheets 11A and 11B and the cardboard sheets 11A′ and 11B′ are distributed by the director device 3.

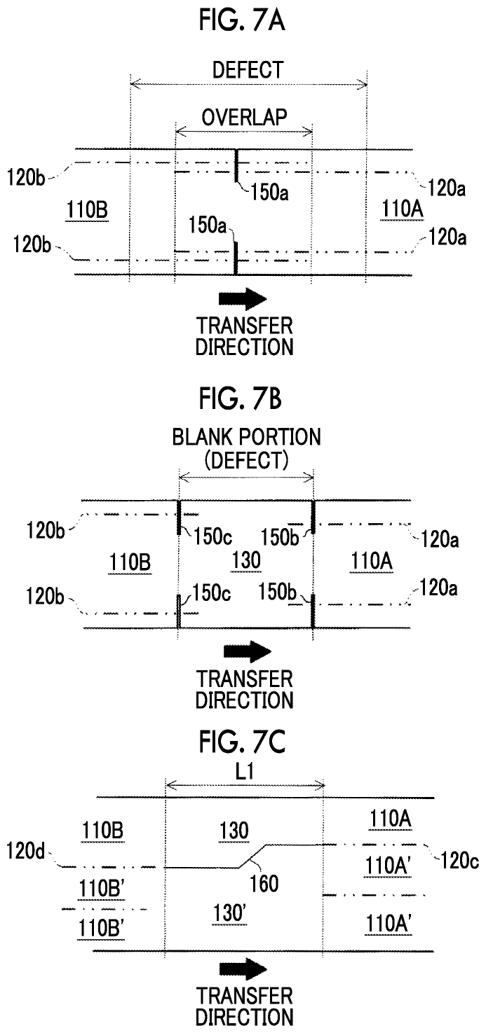

Since the length of a blank portion 130 (see FIG. 7B) is defined by the peripheral length of the edge-cutting knife 51 in the related art, there is a case where the edge-cutting knife 51 should be rotated excessively in the case of a certain order changing time. For this reason, an increase in the length of a defective sheet is caused.

In this regard, according to the edge-cutting device 5 of this embodiment, a time interval between the first edge cutting for forming the first edge cut 15b and the second edge cutting for forming the second edge cut 15c is variably controlled by a time required to form the center cut 16. For this reason, a distance between the first edge cut 15b and the second edge cut 15c is a distance corresponding to the time required to form the center cut 16. That is, the length of each of the blank portions 13 and 13′ (a length in the transfer direction) is the minimum length corresponding to the time required to form the center cut 16. For this reason, an increase in the length of each of the blank portions 13 and 13′ excluded as defects is suppressed. Accordingly, an increase in the length of a defective sheet caused by the changing of an order can be suppressed.

[6. Effect]

(1) In the above-mentioned edge-cutting device 5, the calculation means 72 calculates an order changing time and the variable control means 74 variably controls the time interval between the first edge cutting and the second edge cutting at the order changing time. Accordingly, a distance between the first edge cut 15b and the second edge cut 15c can be minimized with respect to the lengths of the blank portions 13 and 13′ required for the changing of an order, so that an increase in the length of a defective sheet caused by the changing of an order is suppressed. Therefore, since an increase in the length of a defective sheet caused by the changing of an order can be suppressed, productivity is improved.

(2) Further, in the above-mentioned edge-cutting device 5, the variable control means 74 controls the rotation speed of each edge-cutting knife 51 from the end point in time of the first edge cut 15b to the start point in time of the second edge cut 15c. For this reason, since the time interval can be variably controlled accurately at the order changing time, a distance between the first edge cut 15b and the second edge cut 15c can be minimized with respect to the lengths of the blank portions 13 and 13′.

(3) Furthermore, in the above-mentioned edge-cutting device 5, the center-cutting time, which is required to form the center cut 16 by the center-cutting device 6, is employed as the order changing time. Accordingly, the time interval between the first edge cutting and the second edge cutting can be variably controlled appropriately for every order.

(4) Moreover, in the above-mentioned edge-cutting device 5, the slitter scorer-setting time required to switch the slitter scorers to the setting for a new order from the setting for an old order is employed as the order changing time. Accordingly, the time interval between the first edge cutting and the second edge cutting can be variably controlled appropriately for every order.

(5) Further, in the above-mentioned edge-cutting device 5, a longer time of the center-cutting time and the slitter scorer-setting time is employed as the order changing time. Accordingly, the time interval between the first edge cutting and the second edge cutting can be variably controlled using an optimum order changing time depending on the configuration of the corrugating machine.

[7. Others]

The above-mentioned configuration of the corrugating machine 1 is merely an example, and the corrugating machine 1 is not limited to the above-mentioned configuration.

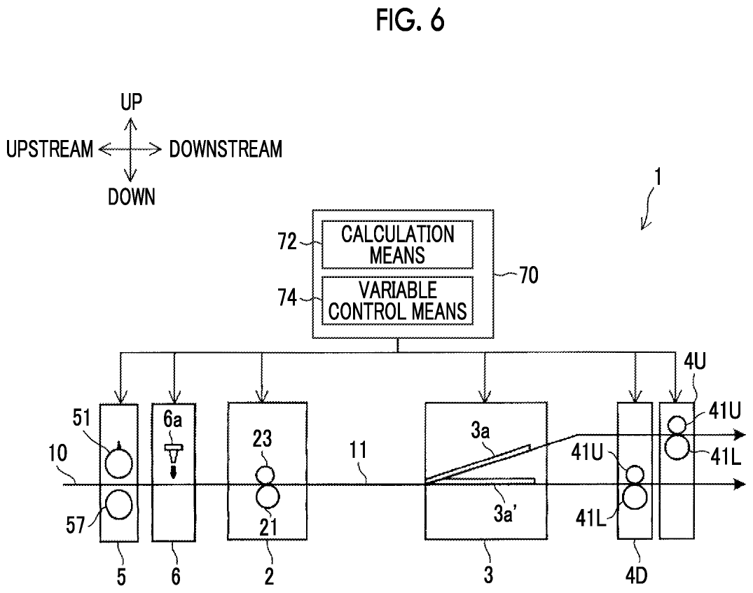

For example, even in a case where the corrugating machine 1 is a single slitter type corrugating machine including only one slitter scorer 2 as shown in FIG. 6, the edge-cutting device 5 according to this embodiment can be applied. In this case, in order to cope with the changing of an order without stopping the corrugating machine 1, the slitter knife 21 of the slitter scorer 2 being operating is moved to a retreat position from an operating position at the end timing of an old order first, is moved in the machine width direction to a slitting position corresponding to the next order (new order) in this state, and then returns to the operating position from the retreat position. Accordingly, in the structure including the single slitter, a slitter scorer-setting time includes a time required to move the slitter knife 21 in the machine width direction and a time required to move the slitter knife 21 between the operating position and the retreat position. On the other hand, the configuration of the center-cutting device 6 is the same as that described above. The calculation means 72 is adapted to calculate the center-cutting time and the slitter scorer-setting time and to employ a longer time of the calculated center-cutting time and the calculated slitter scorer-setting time as the order changing time. Accordingly, the time interval between the first edge cutting and the second edge cutting can be variably controlled using an optimum order changing time depending on the configuration of the corrugating machine.

Further, the variable control of the rotation speeds of the edge-cutting knives 51 performed by the variable control means 74 is not limited to the deceleration control exemplified in FIG. 4 and may be acceleration control.

Furthermore, the variable control of the time interval between the first edge cutting and the second edge cutting performed by the variable control means 74 is not limited to the variable control of the rotation speeds (acceleration/deceleration) of the edge-cutting knives 51.

### REFERENCE SIGNS LIST

1: corrugating machine
2A: first slitter scorer
2B: second slitter scorer
21: slitter knife
3: director device
4U: upper cut-off device
4D: lower cut-off device
5: edge-cutting device
6: center-cutting device
6a: jet nozzle
11: belt-like double-faced cardboard sheet
11A: cardboard sheet of old order
11B: cardboard sheet of new order
12a, 12b: slit
13: blank portion
51R: first edge-cutting knife
51L: second edge-cutting knife
51a: cylinder
70: control device
72: calculation means
74: variable control means

1. An edge-cutting device that performs edge cutting for cutting away a trim of a cardboard sheet forward and backward in a case where an order is changed in a corrugating machine, the edge-cutting device comprising:
an edge-cutting knife that protrudes from an outer periphery of a cylinder of which an axis is disposed in a width direction of the corrugating machine and is rotated integrally with the cylinder; and
a control device that controls the edge-cutting device to cause the edge-cutting device to perform first edge cutting for edge-cutting a trim of an old order at a first rotation of the edge-cutting knife and to perform second edge cutting for edge-cutting a trim of a new order at a second rotation of the edge-cutting knife in a case where the order is changed,
wherein the control device includes calculation means for calculating an order changing time, and variable control means for variably controlling a time interval between the first edge cutting and the second edge cutting in the order changing time.

2. The edge-cutting device according to claim 1,
wherein the variable control means controls a rotation speed of the edge-cutting knife between an end point in time of the first edge cutting and a start point in time of the second edge cutting.

3. The edge-cutting device according to claim 1,
wherein the corrugating machine includes a center-cutting device that forms a center cut connecting a position of a slit of the cardboard sheet of the old order to a position of a slit of the cardboard sheet of the new order in a case where the order is changed, and
the calculation means calculates a center-cutting time, which is required to form the center cut by the center-cutting device, as the order changing time.

4. The edge-cutting device according to claim 1,
wherein the corrugating machine includes a slitter scorer that forms a slit in a transfer direction in the cardboard sheet, and
the calculation means calculates a slitter scorer-setting time, which is required to switch the slitter scorer to setting for the new order from setting for the old order, as the order changing time in a case where the order is changed.

5. The edge-cutting device according to claim 1,
wherein the corrugating machine includes a center-cutting device that forms a center cut connecting a position of a slit of the cardboard sheet of the old order to a position of a slit of the cardboard sheet of the new order in a case where the order is changed and a slitter scorer that forms a slit in a transfer direction in the cardboard sheet, and
the calculation means calculates a center-cutting time which is required to form the center cut by the center-cutting device and a slitter scorer-setting time which is required to switch the slitter scorer to setting for the new order from setting for the old order in a case where the order is changed and employs a longer time of the center-cutting time and the slitter scorer-setting time as the order changing time.
